(19) United States
(12) Patent Application Publication
(10) Pub. No.: US 2012/0315079 A1
(43) Pub. Date: Dec. 13, 2012

(54) EQUALIZER BAR BEARING ASSEMBLY

(75) Inventor: Joshua Nuechterlein, Washington, IL (US)

(73) Assignee: Caterpillar Inc., Peoria, IL (US)

(21) Appl. No.: 13/277,264

(22) Filed: Oct. 20, 2011

Related U.S. Application Data
(60) Provisional application No. 61/422,840, filed on Dec. 14, 2010.

(51) Int. Cl. B62D 55/092; F16C 11/04; F16C 33/10

(52) U.S. Cl. 403/34; 384/322

(57) ABSTRACT

The disclosure describes, in one aspect, a bearing assembly including an outer portion and an inner portion adapted to receive an end of a bar. The inner portion includes a fluidic groove extending from a first end of the bearing assembly to a second end of the bearing assembly permitting fluid to flow through the first end and the second end.

### TECHNICAL FIELD

The disclosure generally relates to an equalizer bar bearing assembly and in particular, but not exclusively, to a bar bearing assembly for connecting a track roller frame to an equalizer bar of a track-type machine.

### BACKGROUND

Track type machines commonly use an equalizer bar between both the left and right hand tracks to allow a degree of flexibility in movement of the tracks relative to the main frame. The equalizer bar is operationally mounted to the main frame and the two ends of the equalizer bar are connected with the left hand and right hand side track roller frames respectively. The connection between the equalizer bar and the track roller frame must allow a degree of movement between the equalizer bar and the track roller frame whilst being able to sustain severe loading.

The movement between the equalizer bar and the track roller frame may cause internal pressures within a pin joint connecting the equalizer bar to the track roller frame to be variable, which may overpressurize seals within the pin joint. U.S. Pat. No. 5,799,950 to Allen et al. (the '566 patent) discloses a pin joint assembly having the ability to equalize the pressure within the joint to avoid excessive pressure build-up.

The disclosed embodiments are directed to overcoming one or more of the problems set forth above and other problems in the art.

### SUMMARY OF THE INVENTION

The disclosure describes, in one aspect, a bearing assembly including an outer portion and an inner portion adapted to receive an end of a bar. The inner portion includes a fluidic groove extending from a first end of the bearing assembly to a second end of the bearing assembly permitting fluid to flow through the first end and the second end.

### BRIEF DESCRIPTION OF THE DRAWINGS

FIG. 1 is a diagrammatic representation of an exemplary machine having a bearing assembly in accordance with an embodiment of the present disclosure.

FIG. 2 schematically illustrates a more detailed view of a portion of the arrangement of FIG. 1 in accordance with the present disclosure.

FIG. 3 is a cross section taken along line 3-3 of FIG. 2 showing a portion of the track roller frame and the equalizer bar in accordance with the present disclosure.

FIG. 4A schematically illustrates an embodiment of the bearing assembly in accordance with the present disclosure.

FIG. 4B schematically illustrates an embodiment of the bearing assembly in accordance with the present disclosure.

FIG. 5A schematically illustrates an embodiment of the bearing assembly in accordance with the present disclosure.

FIG. 5B schematically illustrates an embodiment of the bearing assembly in accordance with the present disclosure.

FIG. 5C schematically illustrates an embodiment of the bearing assembly in accordance with the present disclosure.

FIG. 6A schematically illustrates an embodiment of the bearing assembly in accordance with the present disclosure.

FIG. 6B schematically illustrates an embodiment of the bearing assembly in accordance with the present disclosure.

FIG. 6C schematically illustrates an embodiment of the bearing assembly in accordance with the present disclosure.

### DETAILED DESCRIPTION

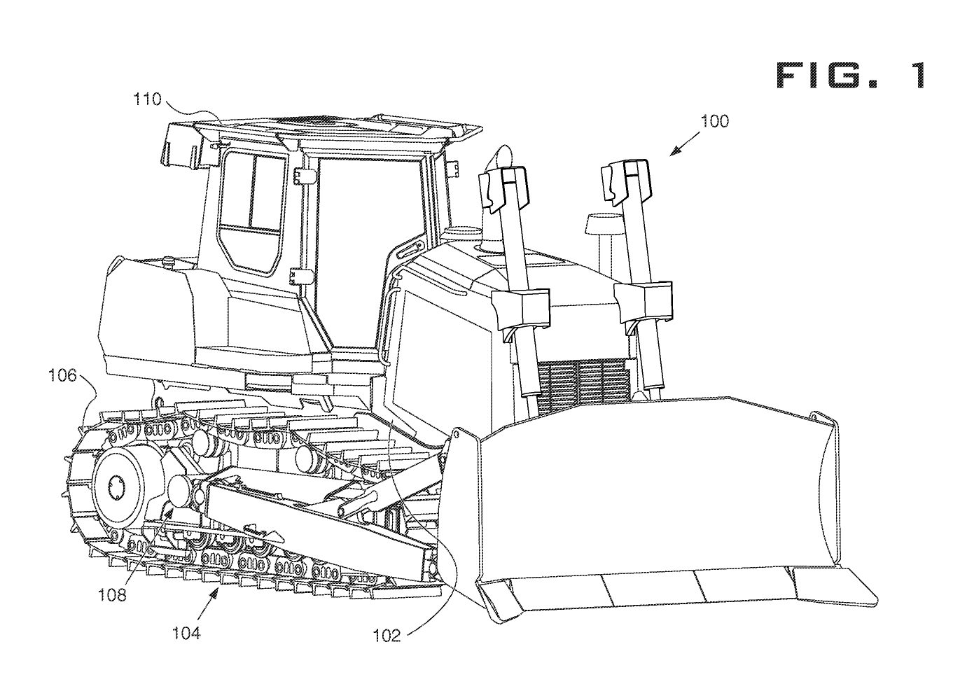

An exemplary embodiment of a machine 100 is shown schematically in FIG. 1. The machine 100 may be a mobile machine that performs some type of operation associated with an industry such as mining, construction, farming, transportation, or any other industry known in the art. For example, the machine 100 may be a track-type tractor, as depicted in FIG. 1, having a frame 102 and a tracked undercarriage 104 operationally mounted to the frame 102. The undercarriage 104 may include a pair of track chains 106 entrained about a pair of laterally spaced track roller frames 108.

A power source, such as, for example, an electric motor, hydraulic motor, or engine may be used to actuate the undercarriage 104 to move the track chains 106 about the track roller frames 108 to propel or move the machine 100. The track roller frames 108 may include a plurality of undercarriage 104 components, such as, for example, rollers or bogeys, carrier rollers, idlers, and other conventional components, that support and guide the track chain 106 as it moves about the track roller frames 108 and moves the machine 100. The machine 100 may also include a cab 110.

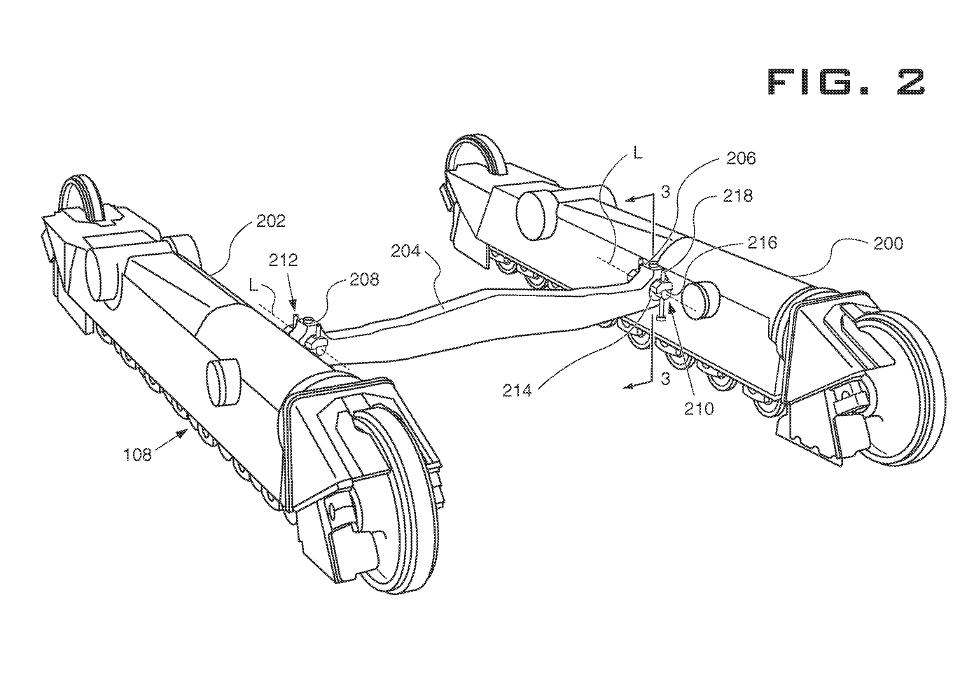

Referring to FIG. 2, the track roller frames 108 may be embodied as a first track roller frame 200 and a second track roller frame 202. An equalizer bar 204 may be disposed between the first 200 and second 202 track roller frames. A first end 206 of the equalizer bar 204 may be connected to the first track roller frame 200 and a second end 208 may be connected to the second track roller frame 202. The first end 206 is connected to the first track roller frame 200 in a connection arrangement embodied as a first end joint 210. Likewise, the second end 208 is connected to the second track roller frame 202 in a connection arrangement embodied as a second end joint 212.

The first 210 and second 212 end joints may be adapted, for example, to accommodate movement of the first 200 and second 202 track roller frames when the machine 100 travels over uneven terrain. Both the first 200 and second 202 track roller frames may be connected to the equalizer bar 204 in the same manner and with similar features and similar function; therefore, only the first end joint 210 connecting the first track roller frame 200 to the first end 206 of the equalizer bar 204 will be discussed in further detail. It is, however, to be understood that the same principles and teachings of the disclosure apply equally to the second end joint 212 connecting the second track roller frame 202 to the second end 208 of the equalizer bar 204.

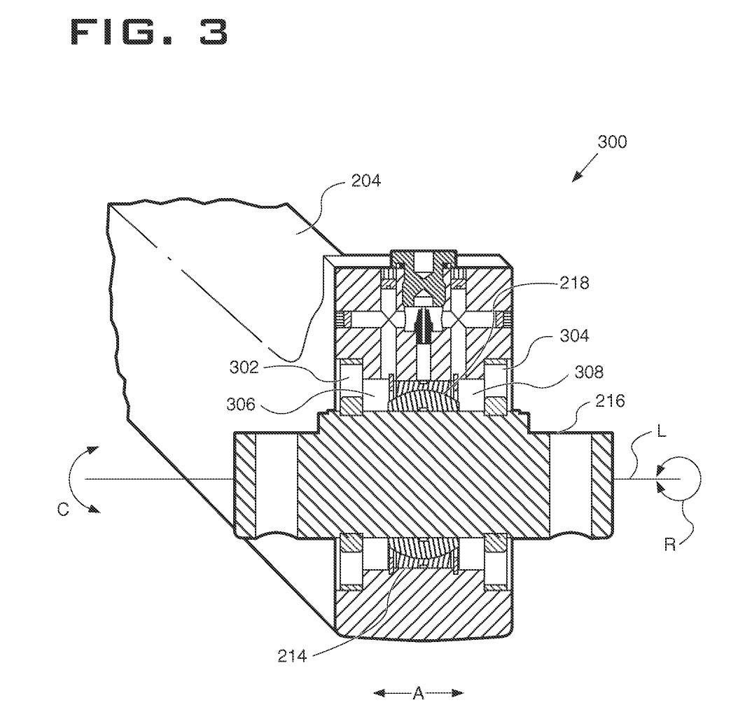

The first end 206 of the equalizer bar 204 may include a passage 214 adapted to receive a pin 216 that is moveably disposed within the passage 214. A bearing 218, which can be more clearly seen in FIG. 3, may be disposed within the passage 214 and adapted to receive the pin 216 to permit the pin 216 to be moveably connected to the equalizer bar 204. The bearing 218 may be held in place within the passage 214 by any suitable means, such as, for example, press fitting.

The pin 216 may extend through the bearing 218 along a longitudinal axis L and may project from at least one side of the equalizer bar 204. In some embodiments, the pin 216 may extend along the longitudinal axis L and project from two sides of the equalizer bar 204. The pin 216 is further adapted to move relative to the equalizer bar 204 such that the pin 216 has a plurality of rotational degrees of freedom along the longitudinal axis L.

Referring to FIG. 3, a cross section taken along lines 3-3 of FIG. 2 illustrates a portion of the equalizer bar 204 and the track roller frame 108. A pin joint assembly is generally shown at 300 including the pin 216 and the bearing 218. The pin 216 and the bearing 218 define a connection arrangement with the equalizer bar 204 that permits the pin 216 to rotate in the direction R along the longitudinal axis L, to cock in the direction C along a vertical plane relative to the longitudinal axis L, and to translate axially in the direction A along a horizontal plane relative to the longitudinal axis L. In some embodiments, the pin 216 movement may be described using three degrees of freedom commonly known as pitch, yaw, and roll.

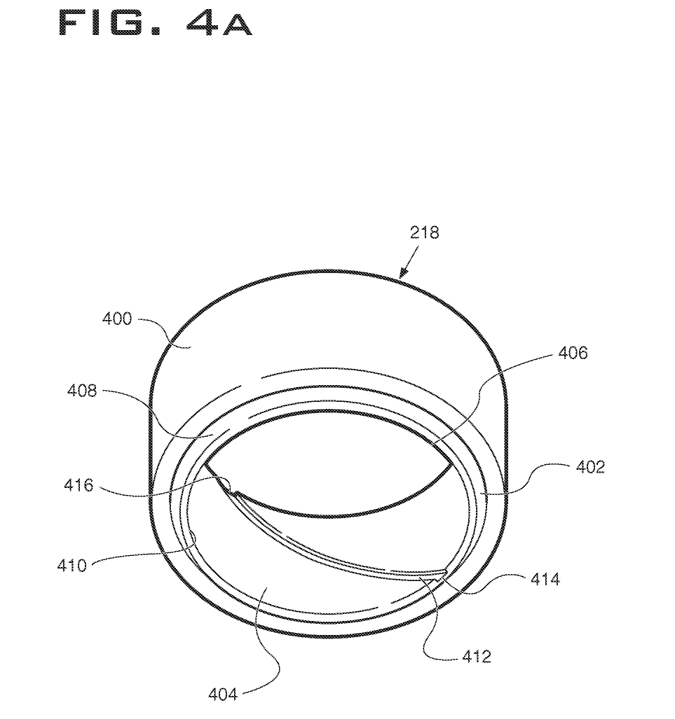

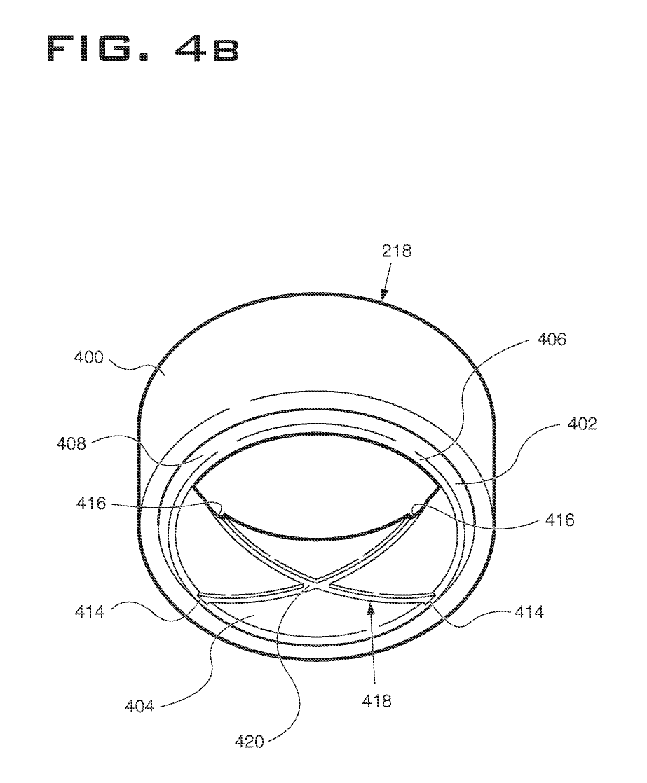

In some embodiments, the bearing 218 may include, as shown, for example, in FIG. 4A, an outer member 400 and an inner member 402. The inner member 402 may be adapted to move and rotate within the confines of the outer member 400 during normal operation. The inner member 402 may include an inner surface 404 that defines a bearing passage 406 through which the pin 216 extends along its longitudinal axis L. The inner surface 404 may be in contact or engaged with the pin 216. In some embodiments, the pin 216 and the inner member 402 may be an integral unit (not shown).

In some embodiments, the outer member 400 may be spherical and the inner member 402 may be cylindrical. In some embodiments, the outer member 400 may be cylindrical and the inner member 402 may be spherical. In some embodiments, the inner member 402 may include an outer portion 408 having a generally spherical configuration and an inner portion 410 having a generally cylindrical configuration. Nevertheless, other configurations with other geometries are also contemplated.

In some embodiments, the inner surface 404 may embody a generally concave surface to satisfactorily engage the pin 216 having a corresponding convex configuration. In some embodiments, the inner surface 404 may embody a generally flat surface to satisfactorily engage the pin 216 having a corresponding flat surface. The inner surface 404 may include both generally concave portions and generally flat portions.

Referring to FIG. 3, the pin joint assembly 300 may further include laterally spaced seals 302, 304 disposed on each side of the bearing 218 within the passage 214 of the equalizer bar 204. A first cavity 306 is disposed between the seal 302 and the bearing 218. A second cavity 308 is disposed between the seal 304 and the bearing 218. The seals 302, 304 are suitable for sealing the pin 216 within the passage 214. The seals 302, 304 may be adapted to have a tight interference fit with the pin 216.

An appropriate lubricating fluid (not shown) is fluidly communicated into and/or within the pin joint assembly 300 and into the cavities 306, 308 to permit the engaged bearing surfaces and pin surfaces to be continuously lubricated. The cavities 306, 308 are substantially filled with the lubricating fluid. Lubricating fluid substantially accumulated within the cavities 306, 308 may cause an internal pressure P and an internal volume V within the cavities 306, 308 to fluctuate as a result of operational movement within the pin joint assembly 300. An internal pressure P change in either the first cavity 306 or the second cavity 308 may overpressurize the corresponding seal 302, 304.

The bearing 218 may be adapted to permit fluidic communication between the cavities 306, 308, such as, for example, a fluidic passageway between the first cavity 306 and the second cavity 308 across or through the bearing 218. Fluidic communication between the cavities 306, 308 may permit the internal pressure P within the cavity 306, 308 to be neutralized or equalized within the pin joint assembly 300 so that no lubricating fluid is leaked into the atmosphere. Neutralizing or equalizing the internal pressure P may protect the seals 302, 304 from bulging as a result of excessive pressure and from subsequent damage.

Referring to FIGS. 4A & 4B, the inner member 402 of the bearing 218 may include at least one fluidic groove 412 extending across the inner surface 404 from a first end 414 to a second end 416 of the bearing 218. The first end 412 may be proximate to at least one of the first 306 and second 308 cavities. The second end 414 may be proximate to the other of the first 306 and second 308 cavities. The at least one fluidic groove 412 allows fluidic communication between the cavities 306, 308, such that fluid is permitted to flow from the first cavity 306 to the second cavity 308 and alternatively from the second cavity 308 to the first 306 to neutralize or equalize the corresponding pressures P in each cavity.

For example, during pin 216 translation in the axial direction A, pressure may increase, for example, in the first cavity 306. The at least one fluidic groove 412 may permit fluid to flow from the first cavity 306 across the inner surface 404 to the second cavity 308, which consequently reduces the pressure in the first cavity 306 and equalizes the pressure in the pin joint assembly 300.

In some embodiments, the at least one groove 412 may embody a helical configuration. In some embodiments, the at least one groove 412 may extend directly across the inner surface 404. In some embodiments, the inner member 402 may include a plurality of grooves 418. The plurality of grooves 418 may include more than one helical grooves 412. As shown in FIG. 4B, the plurality of grooves 418 may intersect to define a cross-groove configuration 420, which permits the fluid to flow between the plurality of grooves 418.

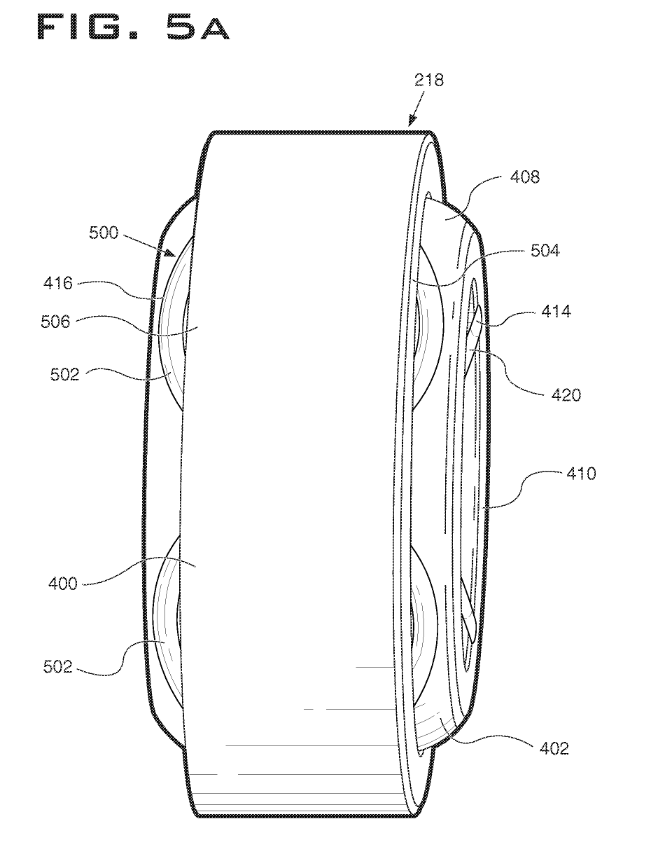

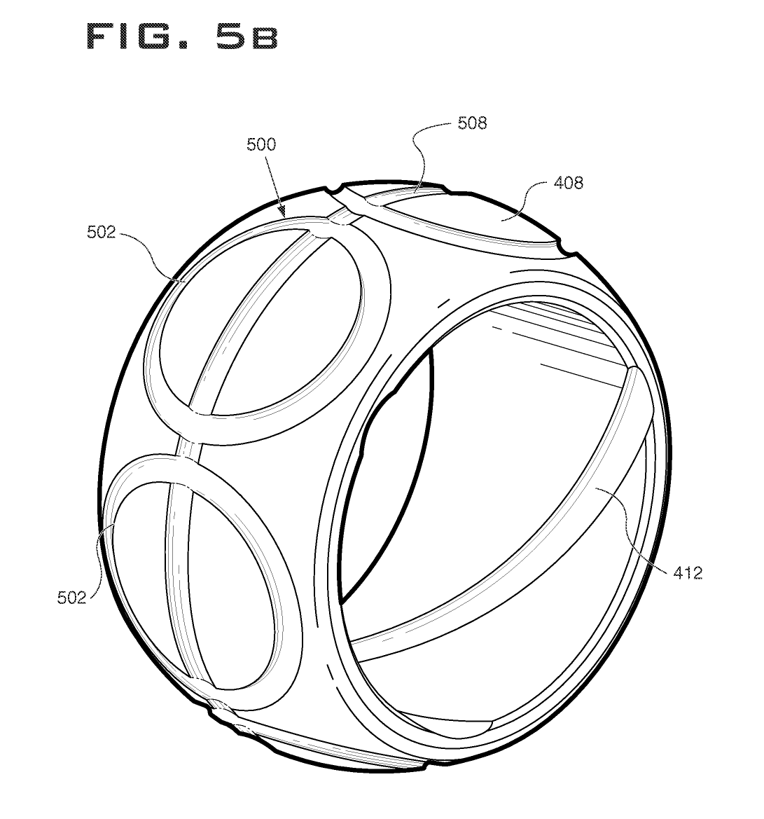

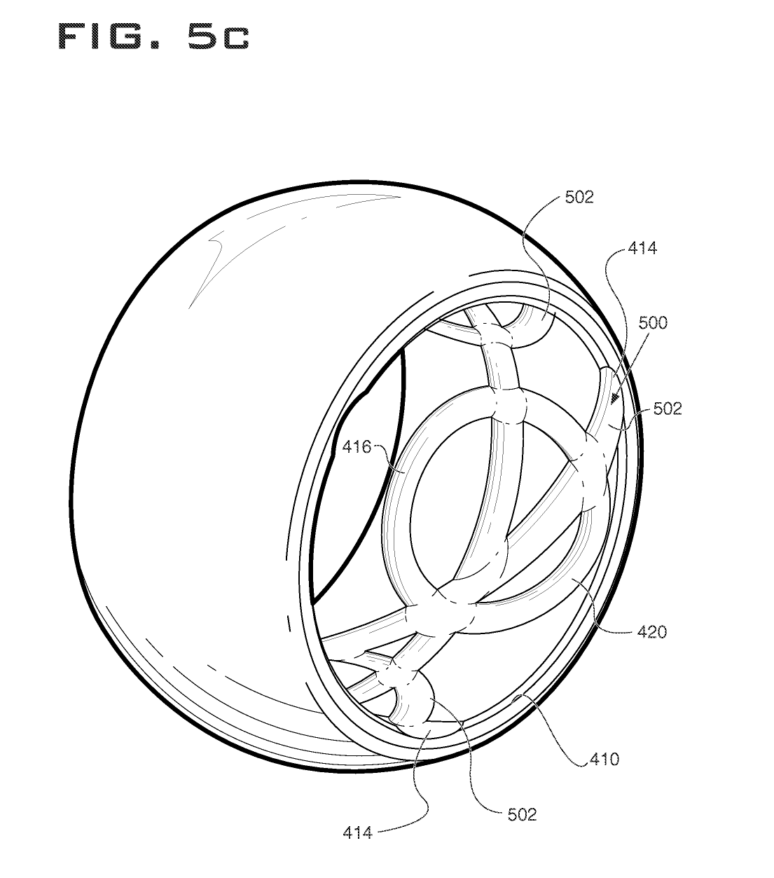

As shown in FIGS. 5A, 5B, & 5C, a plurality of grooves 500 may include at last one groove having a circular configuration 502. The plurality of grooves 500 may further include a plurality of circular configuration grooves 502. The plurality of grooves 500 may be disposed on the outer portion 408 of the bearing 218. When the plurality of grooves 500 is disposed on the outer portion 408, the circular configuration grooves 502 extend beyond each side 504, 506 of the outer member 400, as shown in FIG. 5A, to permit fluid to flow from the first cavity 306 to the second cavity 308 and alternatively from the second cavity 308 to the first 306 to neutralize or equalize the corresponding pressures P in each cavity.

As shown in FIGS. 5B & 5C, the plurality of grooves 500 may embody different geometric configurations. Such as, for example, a single groove 508 circumferentially disposed along the outer portion 408 of the inner member 402 interacting with the circular configuration grooves 502. As shown in FIG. 5C, the plurality of grooves 500 may be disposed on the inner portion 410 of the bearing 218. The plurality of grooves 500 may include circular configuration grooves 502 interacting with at least one of the helical configuration grooves 412, the cross configuration grooves 420, or interacting with a plurality of the helical configuration grooves 412 and the cross configuration grooves 420. The plurality of grooves 500 may be configured to interact in any combination of the geometric configurations discussed above.

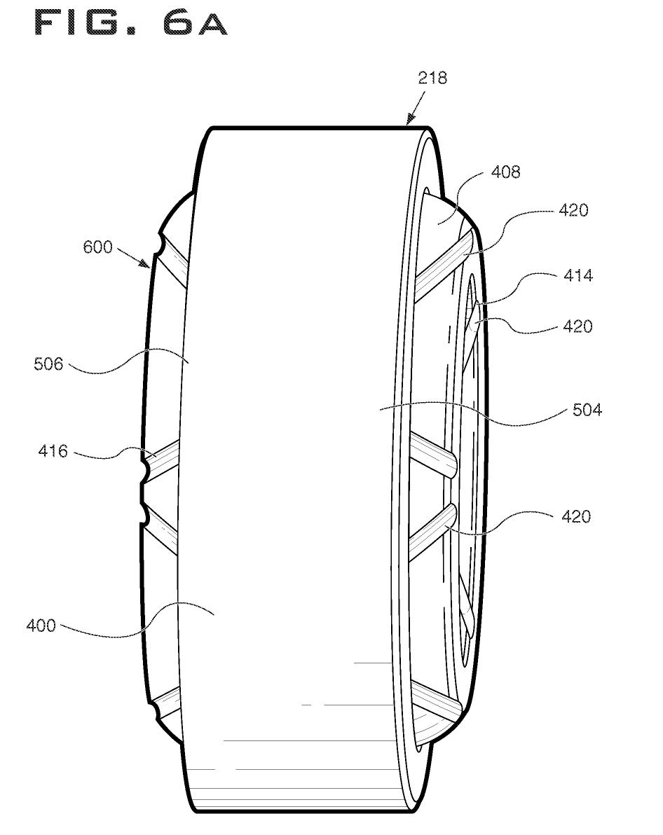

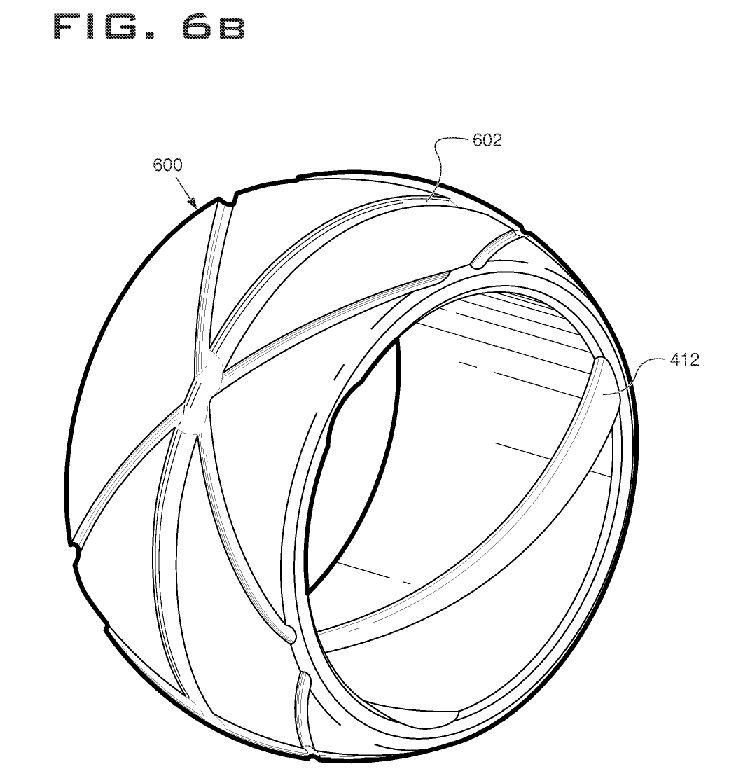

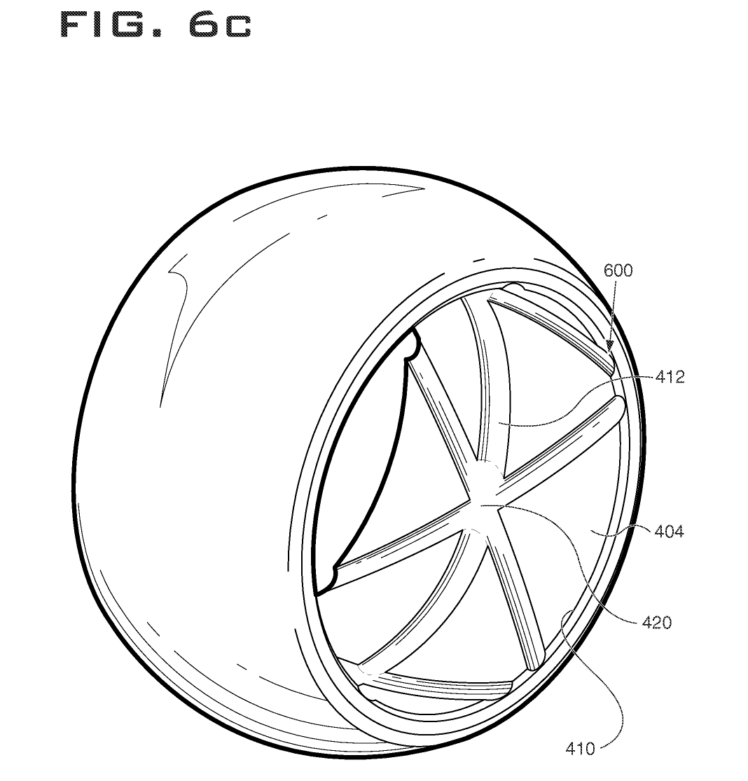

As shown in FIGS. 6A, 6B, & 6C, a plurality of grooves 600 may include at last one groove having a cross-groove configuration 420. The plurality of grooves 600 may further include a plurality of cross-groove configurations 420. The plurality of grooves 600 may be disposed on the outer portion 408 of the bearing 218. When the plurality of grooves 600 is disposed on the outer portion 408, the cross-groove configurations 420 extend beyond each side 504, 506 of the outer member 400, as shown in FIG. 6A, to permit fluid to flow from the first cavity 306 to the second cavity 308 and alternatively from the second cavity 308 to the first 306 to neutralize or equalize the corresponding pressures P in each cavity.

As shown in FIGS. 6B & 6C, the plurality of grooves 600 may embody different geometric configurations. Such as, for example, a single groove 602 circumferentially disposed along the outer portion 408 of the inner member 402 interacting with the cross-grooves 420. As shown in FIG. 6C, the plurality of grooves 600 may be disposed on the inner portion 410 of the bearing 218. The plurality of grooves 600 may include cross-groove configurations 420 interacting with at least one of the helical configuration grooves 412 or interacting with a plurality of the helical configuration grooves 412. The plurality of grooves 600 may be configured to interact in any combination of the geometric configurations discussed above.

### INDUSTRIAL APPLICABILITY

Machines having a tracked undercarriage having a pair of track roller frames mounted to the frame of the machine and connected to an equalizer bar at each end may include but are not limited to track type tractors, hydraulic excavators, tracked loaders, multi-terrain loaders, as well as other types of earth moving and industrial equipment. As the machines travel across terrains with varying contours, pin joints of the equalizer bar having lubricating fluid, such as, for example, oil, may have variable internal pressures that cause excessive pressure to damage seals within the pin joints. Having at least one groove disposed in or across a bearing within the pin joint allows the lubricating fluid to flow through the bearing and consequently neutralize or equalize the pressure.

The selected configuration geometry of the groove, the location of the groove, and the corresponding number of grooves, may be determined based on the type of machine and its application. Experimental analysis and/or simulations, may determine pressure drop comparisons between the cavities within the pin joint and the grooves. The appropriate groove configuration may be determined based on the cavity pressure changes, such as, for example caused by pin translation. A maximum volume change may be allowed for a specific period of time. For example, for a large track type tractor, a maximum volume change of 18,300 mm³ for 0.2 seconds may be permitted. A desired fluid flow rate may be calculated and the appropriate groove configuration selected accordingly.

Although the preferred embodiments of this disclosure have been described herein, improvements and modifications may be incorporated without departing from the scope of the following claims.

What is claimed is:

1. A bearing assembly comprising:
an outer portion; and
an inner portion adapted to receive an end of a bar, the inner portion including a fluidic groove extending from a first end of the bearing assembly to a second end of the bearing assembly permitting fluid to flow through the first end and the second end.

2. The bearing assembly of claim 1, wherein the outer portion is spherical and the inner portion is cylindrical.

3. The bearing assembly of claim 1, wherein the inner portion includes a plurality of grooves.

4. The bearing assembly of claim 3, wherein at least one of the plurality of grooves has a helical configuration.

5. The bearing assembly of claim 3, wherein at least two of the plurality of grooves intersect defining a cross-groove configuration.

6. The bearing assembly of claim 5, wherein the plurality of grooves include a plurality of cross-groove configurations.

7. The bearing assembly of claim 6, wherein the plurality of grooves include at least six cross-groove configurations.

8. The bearing assembly of claim 5, wherein the plurality of grooves includes at least one fluidic groove extending from the first end to the second end of the bearing assembly and the cross-groove configuration.

9. The bearing assembly of claim 8, wherein the at least one fluidic groove is helical.

10. The bearing assembly of claim 9, wherein the plurality of grooves include at least two fluidic helical grooves and a plurality of cross-groove configurations.

11. The bearing assembly of claim 10, wherein the plurality of grooves includes the at least two fluidic helical grooves and at least six cross-groove configurations.

12. The bearing assembly of claim 10, wherein the at least two fluidic helical grooves interact with the plurality of cross-groove configurations to allow fluid communication between the at least two fluidic helical grooves and the plurality of cross-groove configurations.

13. The bearing assembly of claim 3, wherein at least one of the plurality of grooves has a circular configuration.

14. The bearing assembly of claim 13, wherein the plurality of grooves includes a plurality of circular groove configurations.

15. The bearing assembly of claim 12, wherein the plurality of grooves includes at least six circular groove configurations.

16. The bearing assembly of claim 13, wherein the plurality of grooves includes the at least one circular groove configuration and at least one fluidic groove extending from the first end to the second end of the bearing assembly.

17. The bearing assembly of claim 16, wherein the plurality of grooves includes the at least one circular groove configuration and at least two fluidic grooves.

18. The bearing assembly of claim 17, wherein the plurality of grooves includes a plurality of the circular groove configurations and the at least two fluidic grooves.

19. The bearing assembly of claim 17, wherein the plurality of grooves includes at least six of the circular groove configurations and the at least two fluidic grooves.

20. A pin joint assembly for a track roller frame, comprising:
a bearing disposed within a passage of the equalizer bar, the bearing adapted to receive a pin and to moveably connect the equalizer bar to the track roller frame;
a pair of laterally spaced seals disposed on each side of the bearing and defining a first cavity and a second cavity between the bearing and each seal;
wherein the bearing includes a fluidic grove extending from a first end of the bearing to a second end of the bearing permitting fluid communication between the first cavity and the second cavity.
